(19) United States
(12) Patent Application Publication
(10) Pub. No.: US 2024/0067769 A1
(43) Pub. Date: Feb. 29, 2024

(54) Hemp Infused Spray Foam Insulation

(71) Applicant: Michael Jason Garsee, West Monroe, LA (US)

(72) Inventor: Michael Jason Garsee, West Monroe, LA (US)

(21) Appl. No.: 18/387,410

(22) Filed: Nov. 6, 2023

(51) Int. Cl. C08G 18/08; C08G 18/10; C08J 9/00; C08J 9/14; C08G 101/00

(52) U.S. Cl. CPC C08G 18/14; C08G 18/10; C08J 9/0014; C08J 9/146; C08G 2101/00; C08G 2330/00; C08J 2201/022; C08J 2203/162; C08J 2375/04

(57) ABSTRACT

Industrial hemp infused polyurethane spray foam insulation compositions are disclosed including a first component and a second component. The first component includes isocyanate, and the second component includes a mixture of polyol and industrial hemp. The first component and the second component are simultaneously mixed and sprayed using a spray gun to form the industrial hemp infused polyurethane spray foam insulations.

### BACKGROUND OF THE INVENTION

### Field of the Invention

The present invention generally relates to a polyurethane (PU) spray foam and more particularly to a PU spray foam composition including industrial hemp as a filler.

### Description of the Related Art

Polyurethane (PU) spray foam is generally used for insulating and sound proofing roofs and walls of buildings, and sealing air gaps. In addition, the PU spray foam is used to add structural strength to the walls, roofs, and foundations.

The PU spray foam is typically formed by mixing chemicals including polyol and isocyanate. These chemicals are kept in two separate containers in liquid form. For example, isocyanate (typically known as “A side” or “Part A” of PU spray foam) is kept in a first container, and polyol (typically known as “B side” or “Part B” of PU spray foam) is kept in a second container. During application of the PU spray foam on a wall or a roof, polyol and isocyanate get mixed at a tip of a spray gun of a PU spray foam system. When polyol and isocyanate mix, they react with each other to form a foam solution. This foam solution then dries and creates an effective and improved air and vapor barrier, thus helping in insulating and sound proofing the wall or the roof.

Typically, there exists a variety of spray foams. For example, the spray foam may be low density or open cell spray foam, medium density or closed cell spray foam, or closed cell roofing spray foam. A spray foam is typically selected based on an “R-value” associated with the spray foam, which indicates quality of the foam. Efforts are continuously being made to improve the quality of the spray forms, and increase their R-values.

Although some improvements to technologies have increased the R-values of the spray forms; however, the conventional spray forms still do not have high R-values.

Accordingly, there is a need for a PU spray foam that has a higher R-value and structural strength than conventional spray foams.

As disclosed in this application, the inventor has discovered a novel and unique PU spray foam composition that results in higher R-value and structural strength of structures insulated with the spray foams of the compositions disclosed herein.

The compositions disclosed herein overcome many of the drawbacks of existing spray foams.

It is one prospect of the present invention to provide novel PU spray foam compositions for improved insulation and structural strength of PU spray foam and a process of preparation for the novel PU spray foam compositions.

Embodiments of the present invention provide for novel PU spray foam compositions and processes of preparation of the novel PU spray foam compositions as described and defined in the description below and in the annexed claims which provide for higher R-values and also provide for increased structural strength in walls, roofs, and foundations of homes, warehouses, and buildings.

### SUMMARY OF THE INVENTION

The following presents a simplified summary of the present disclosure in a simplified form as a prelude to the more detailed description that is presented herein.

Therefore, in accordance with embodiments of the invention, there is provided an industrial hemp infused polyurethane spray foam composition for insulation. In one embodiment, the composition includes a first component and a second component. The first component (i.e., the “A” side) includes isocyanate, and the second component (i.e., the “B” side) includes a mixture of polyol and an industrial hemp. In one embodiment, the first component and the second component are sprayed simultaneously into a mixture to form the industrial hemp infused polyurethane spray foam adapted for structural insulation of houses, buildings and warehouses.

In one embodiment, the isocyanate is selected from a group consisting of an aliphatic isocyanate, a cycloaliphatic isocyanate, an aromatic isocyanate, aliphatic polyisocyanate, a cycloaliphatic polyisocyanate, an aromatic polyisocyanate, and combinations thereof.

In one embodiment, the polyol is selected from a group consisting of a polyether polyol, a polyester polyol, a polybutadiene polyol, a polycaprolactone polyol, a polycarbonate polyol, a hydroxyl-terminated polyolefin polyol, a graft polyol, a polyol derived from a natural source, and combinations thereof.

In a preferred embodiment, the first component and the second component are sprayed in a ratio of 1:1. In such embodiment, the composition comprises 50% by weight of the first component and 50% by weight of the second component.

Preferably, the first component of the composition comprises 100%, by weight, isocyanate. In other embodiments, the first component comprises 80%-99.9%, by weight, isocyanate, and 0.1%-20% other elements.

In one embodiment, the second component comprises 1%-85% by weight industrial hemp and 15%-99% by weight polyol. In another embodiment, the second component includes 15%-75% by weight industrial hemp and 15%-75% by weight polyol. In yet another embodiment, the second component comprises 25%-65% by weight industrial hemp and 25%-65% by weight polyol. In a preferred embodiment, the second component comprises 45%-55% by weight industrial hemp and 45%-55% by weight polyol.

In one embodiment, the industrial hemp infused spray foam composition comprises 12.5%-37.5% by weight industrial hemp, 12.5%-37.5% by weight polyol, and 50% by weight isocyanate. In another embodiment, the industrial hemp infused spray foam composition comprises 18.75%-31.25% by weight industrial hemp, 18.75%-31.25% by weight polyol, and 50% by weight isocyanate.

In one embodiment, the industrial hemp infused spray foam composition consists of 0.1%—hemp, 0.1%-60% by weight polyol, and 25%-75% by weight isocyanate.

In yet another embodiment, the industrial hemp infused spray foam composition consists of 12.5%-37.5% by weight industrial hemp, 12.5%-37.5% by weight polyol, and 40%-60% by weight isocyanate.

In a preferred composition, a polyurethane spray foam composition is provided consisting of: 12.5%-37.5% by weight industrial hemp; 12.5%-37.5% by weight polyol, and 50% by weight isocyanate.

In yet another embodiment, the industrial hemp infused spray foam composition consists of a first component and a second component, wherein the first component consists of 100%, by weight, isocyanate, wherein the second component consists of 1%-85% by weight industrial hemp and 15%-99% by weight polyol.

In another embodiment, the first component consists of 100%, by weight, isocyanate, and the second component consists of 1%-15% by weight industrial hemp and 85%-99% by weight polyol.

In yet another embodiment, the first component consists of 100%, by weight, isocyanate, and the second component consists of 15%-75% by weight industrial hemp and 25%-85% by weight polyol. In a preferred embodiment, the first component of the spray foam composition consists of 100%, by weight, isocyanate, and the second component of the spray foam composition consists of 25%-65% by weight industrial hemp and 35%-75% by weight polyol. In another preferred embodiment, the first component of the spray foam composition consists of 100%, by weight, isocyanate, and the second component of the spray foam composition consists of 50% by weight industrial hemp and 50% by weight polyol.

In yet another preferred embodiment, the first component of the spray foam composition consists of 100%, by weight, isocyanate, and the second component of the spray foam composition consists of 10% by weight industrial hemp and 90% by weight polyol. Such embodiment enables builders and contractors to apply the disclosed industrial hemp-infused spray foam using conventional machines where the nozzle top of the spray foam applicator is smaller than other nozzles. In other words, such embodiment accommodates smaller nozzle tips.

In a most preferred embodiment, the industrial hemp infused spray foam composition consists of 25% by weight industrial hemp, 25% by weight polyol, and 50% by weight isocyanate. In such embodiment the second component (i.e., “B” side) consists of 50% by weight industrial hemp and 50% by weight polyol, and the first component (i.e., “A” side) consists of 100% by weight isocyanate. In additional embodiments, the composition further includes a blowing agent.

In another embodiment of the present invention, there is provided a polyurethane spray foam system. The system includes a first container having a first component and a second container having a second component. In one embodiment, the first component includes isocyanate, and the second component includes a mixture of polyol and a hemp. The system further includes a spray gun for dispensing the first component from the first container and dispensing the second component from the second container. The system additionally includes a plurality of hoses connecting the first container and the second container with the spray gun.

In one embodiment, the first container includes a first valve for dispensing the first component, and the second container includes a second valve for dispensing the second component. In a preferred embodiment, the system comprises a first hose connected to a first container, the system comprises a second hose connected to a second container; and the two hoses adjoin at a manifold having a single flow valve adapted to control the amount of composition being sprayed by a user.

In further embodiments, the spray gun includes a trigger bar. In a preferred embodiment, the spray gun dispenses the first component and the second component when the trigger bar is actuated.

In yet another embodiment of the present disclosure, there is provided a process for preparation of a polyurethane spray foam. The process includes obtaining and processing industrial hemp, and obtaining isocyanate as a first component. The process further includes obtaining polyol and mixing the polyol with industrial hemp to form a second component. The process includes storing the first component and the second component in separate containers. The process additionally includes spraying while mixing simultaneously the first component and the second component to obtain the industrial hemp infused polyurethane spray foam, which has shown to improve the insulation and structural integrity.

The present invention is directed to an industrial hemp infused spray foam insulation for residential, commercial building installation and/or industrial installation, as a new construction material. The hemp infused spray foam insulation provides much improved insulation (higher R-value) for structures, such as homes and buildings, and it also provides structural reinforcement to such structures. In on embodiment, the composition is formulated to form a foam insulation that is resistant to fire.

Further, in a preferred embodiment, the hemp infused spray foam insulation is formulated to be resistant to fire by an inclusion of either ABC powder or BC powder in the mixture.

In a preferred embodiment, the disclosed industrial hemp infused spray foam is also watertight, and when wet, the foam behaves like a sponge or towel. Further, the foam does not split apart when wet, unlike conventional insulation materials.

These and other features, aspects, and advantages of the present invention will become better understood with reference to the following description and appended claims.

### BRIEF DESCRIPTION OF THE DRAWINGS

Illustrative embodiments of the present invention are described herein with reference to the accompanying drawings, in which:

FIG. 1 depicts a polyurethane (PU) spray foam apparatus, in accordance with embodiments of the invention;

FIG. 2 depicts a user spraying PU spray foam on a wall, in accordance with embodiments of the invention; and

FIG. 3 depicts a flow diagram of a method for preparing a hemp infused PU spray foam, in accordance with embodiments of the invention.

### DETAILED DESCRIPTION

For a further understanding of the nature and function of the embodiments, reference should be made to the following detailed description. Detailed descriptions of the embodiments are provided herein, as well as, the best mode of carrying out and employing the present invention. It will be readily appreciated that the embodiments are well adapted to carry out and obtain the ends and features mentioned as well as those inherent herein. It is to be understood, however, that the present invention may be embodied in various forms. Therefore, persons of ordinary skill in the art will realize that the following disclosure is illustrative only and not in any way limiting, as the specific details disclosed herein provide a basis for the claims and a representative basis for teaching to employ the present invention in virtually any appropriately detailed system, structure or manner. It should be understood that the devices, materials, methods, procedures, and techniques described herein are presently representative of various embodiments. Other embodiments of the disclosure will readily suggest themselves to such skilled persons having the benefit of this disclosure.

Reference will now be made in detail to the present preferred embodiments of the invention, examples of which are illustrated in the accompanying drawings. Wherever possible, the same reference numerals are used in the drawings and the description to refer to the same or like parts.

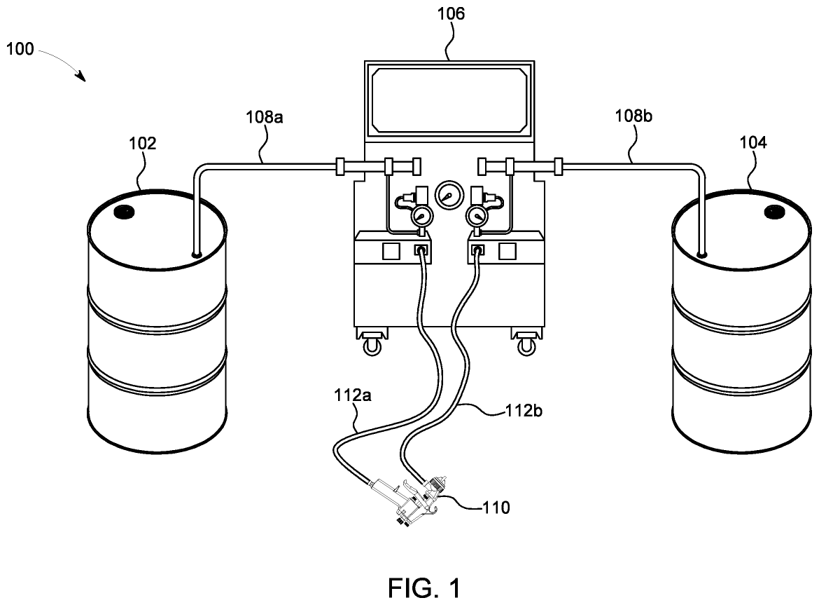

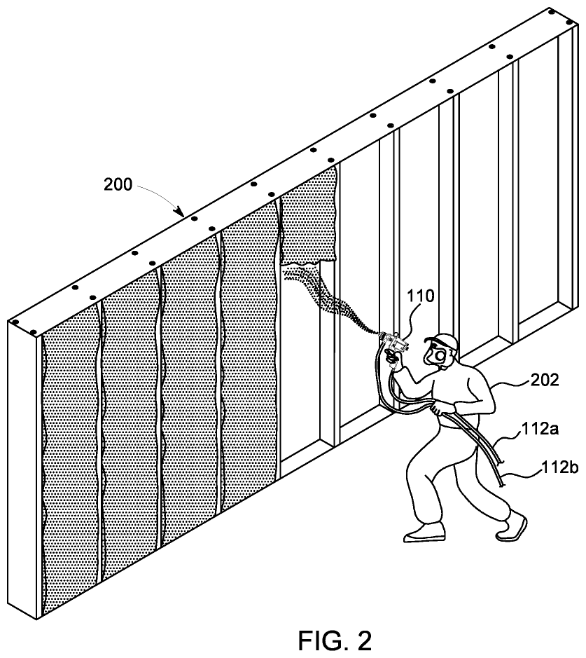

Referring initially to FIG. 1, the basic constructional details and principles of operation of embodiments of a polyurethane (PU) spray foam apparatus 100 are provided. While describing FIG. 1, references will be made to FIG. 2 which depicts a user 202 spraying PU spray foam on a wall 200.

The apparatus 100 includes a first container 102 and a second container 104. The first container 102 and the second container 104 are of any shape and dimension, and are made of any material. For example, in one embodiment, the first container 102 and the second container 104 are cylindrical in shape, and are made of plastic, steel, or any other material. In certain embodiments, the first container 102 and the second container 104 are pressurized cylinders or pressurized cans or containers.

In some embodiments, the first container 102 includes a first component (or “A side” or “Part A” of PU spray foam). In one embodiment, the first component includes isocyanate.

In such embodiment, the second container 104 includes a second component (or “B side” or “Part B” of PU spray foam). The second component is a mixture of polyol and hemp, preferably industrial hemp.

In a preferred embodiment, the first component is placed in the first container 102, preferably at low pressure, such as up to 800 Pound-force per square inch (psi), most preferably between 50 psi to about 300 psi. The second component is placed in the second container 104, preferably at low pressure, such as up to 800 psi, most preferably between 50 psi to about 300 psi. The second component is placed in the second container 104, preferably at low pressure, such as up to 800 psi, most preferably between 50 psi to about 300 psi.

In certain embodiments, the first container 102 includes a first valve (not shown) for dispensing the first component from the first container 102. Similarly, the second container 104 includes a second valve (not shown) for dispensing the second component from the second container 104.

The apparatus 100 further includes a spray foam machine having a pump 106 that is connected with the first container 102 and to the second container 104. In one embodiment, the spray foam machine 106 is connected with the first valve and the second valve to receive the first component and the second component from the first container 102 and the second container 104, respectively. In the exemplary embodiment depicted in FIG. 1, the first container 102 and the second container 104 are connected with the console 106 via a first hose 108a and a second hose 108b, respectively. The first hose 108a is configured to connect the first container 102 with the console 106, and the second hose 108b is configured to connect the second container 104 with the console 106. In some embodiments, the console 106 includes components/units configured to control operation of the apparatus 100. For example, the console 106 includes a motor and a pump to receive the first component and the second component in a predefined ratio. In certain embodiments, the predefined ratio is 1:1.

In further embodiments, the console 106 is configured to output the first component and the second component to a spray gun 110. The console 106 is connected to the spray gun 110 via one or more hoses (e.g., a third hose 112a and a fourth hose 112b). The third hose 112a is configured to output the first component from the console 106 to the spray gun 110, and the fourth hose 112b is configured to output the second component from the console 106 to the spray gun 110.

In certain embodiments, the spray gun 110 includes a trigger bar (not shown). The spray gun 110 is configured to dispense the first component and the second component from the first container 102 and the second container 104, via the console 106, when the trigger bar is actuated. When a user (shown as the user 202 in FIG. 2) depresses the trigger bar, the spray gun 110 receives the first component from the third hose 112a and the second component from the fourth hose 112b, and sprays the first component and the second component simultaneously in the predefined ratio on a framed-up wall (shown as the wall 200 in FIG. 2) through the spray gun 110. When the first component and the second component are simultaneously sprayed in the predefined ratio on the wall 200, the first component and the second component are mixed to form an industrial hemp infused polyurethane (PU) spray foam insulation.

In some embodiments, the third hose 112a is configured to receive and spray isocyanate on the wall 200 via the spray gun 110. Similarly, the fourth hose 112b is configured to receive and spray the mixture of polyol and industrial hemp on the wall 200 via the spray gun 110. When the isocyanate and the mixture of polyol and industrial hemp is sprayed, the isocyanate chemically reacts with the mixture of polyol and industrial hemp to form the PU spray foam (or industrial hemp infused PU spray foam) on the wall 200.

Specifically, the chemicals (i.e., isocyanate and polyol) react to create spray foam, and the industrial hemp fibers are intertwined to create the industrial hemp infused PU spray foam. The industrial hemp infused PU spray foam is dried in place on the wall 200, and the foam then insulates the wall 200. In this manner, the industrial hemp is infused to polyol and isocyanate to form the industrial hemp infused PU spray foam (having isocyanate, polyol, and industrial hemp).

In certain embodiments, the polyol described above is selected from a group consisting of a polyether polyol, a polyester polyol, a polybutadiene polyol, a polycaprolactone polyol, a polycarbonate polyol, a hydroxyl-terminated polyolefin polyol, a graft polyol, a polyol derived from a natural source, and combinations thereof.

A person ordinarily skilled in the art will appreciate that polyols generally have a molecular weight in a range of 200 to 6000 g mole⁻¹, more preferably in a range of 250 to 2000 g mole⁻¹, and most preferably in a range of 250 to 1000 g mole⁻¹. The polyols can have a hydroxyl number (OH number) ranging from 28 to 800 mg/KOH g. Hydroxyl number indicates the number of reactive hydroxyl groups available, and is expressed as the number of milligrams of potassium hydroxide equivalent to the hydroxyl content of one gram of the polyol sample.

The polyols can have a number average hydroxyl functionality (Fn) of about 6.2 or less. Number average hydroxyl functionality refers to the average number of pendant hydroxyl groups (primary, secondary, or tertiary) that are present on a molecule of the polyol.

In addition to preferred polyols derived from petrochemicals, the polyols for use in the present invention can also be derived from a natural source, such as fish oil, lard, tallow, and plant oil. Plant based polyols of the embodiments disclosed herein are preferably made from any plant oil or oil blends containing sites of unsaturation, including, but not limited to, hemp seed oil, soybean oil, castor oil, palm oil, canola oil, linseed oil, rapeseed oil, sunflower oil, safflower oil, olive oil, peanut oil, sesame seed oil, cotton seed oil, walnut oil, and tung oil. In some embodiments, the polyols are preferably derived from a source selected from a group consisting of petrochemicals, hemp seed oil, soybean oil, castor oil, palm oil, canola oil, linseed oil, rapeseed oil, sunflower oil, safflower oil, olive oil, peanut oil, sesame seed oil, cotton seed oil, walnut oil, and tung oil.

The first component, the Side A, contains very reactive chemicals known as isocyanates. The second component, the Side B, contains a polyol and industrial hemp, which react with the isocyanates to make the disclosed industrial hemp infused polyurethane spray foam. In some embodiments, the second component (the B Side) also includes a mixture of other chemicals, including catalysts (which help the reaction to occur), flame retardants, blowing agents and surfactants.

In some embodiments, the isocyanate for use in the present invention is selected from the group consisting of an aliphatic isocyanate, a cycloaliphatic isocyanate, an aromatic isocyanate, aliphatic polyisocyanate, a cycloaliphatic polyisocyanate, an aromatic polyisocyanate, and combinations thereof.

Hemp, or Cannabis sativa or indica, as it is scientifically known, is a fragrant herb that is in the same family as the cannabis plant. In some embodiments, industrial hemp is processed to a predetermined consistency, and the processed industrial hemp is added to the polyol in the second container 104 for use in the present invention. In certain embodiments, the processing of the industrial hemp includes, but is not limited to, ultramilling, phenolation, nano-transformation to obtain nano- and micro-sized industrial hemp particles.

In one embodiment of the present invention, the industrial hemp is mixed with the polyol in a predefined ratio of weight to form the second component in the second container 104. For example, in certain embodiments, the second component (i.e., the “B” side) includes industrial hemp in a range of 1% to about 60% by weight and polyol in a range of 40% to about 99% by weight.

In further embodiments, the first component and the second component are sprayed in a ratio of 1:1. In accordance with other embodiments of the present invention, the first component and the second component are sprayed in other ratios (different from 1:1).

In further embodiments of the present invention, the first container 102 includes a first blowing agent, in addition to including isocyanate. In a similar manner, the second container 104 includes a blend/mixture of polyols, a second blowing agent, industrial hemp, and other components such catalysts, flame retardants, and surfactants.

In a preferred embodiment, the composition comprises 1%-25% by weight (and preferably 20%-25%, by weight), ABC powder or BC powder (as a flame retardant) that is mixed with in the same side as the industrial hemp (i.e., the “B” side). The flame retardant helps make embodiments of the disclosed industrial hemp infused spray foam more resistant to fire. As known in the art, ABC Powder, ABC Dry Chemical, Monoammonium phosphate, tri-class, or multi-purpose dry chemical is a dry chemical extinguishing agent used on class A, class B, and class C fires. It uses a specially fluidized and siliconized monoammonium phosphate powder. ABC dry chemical is usually a mix of monoammonium phosphate and ammonium sulfate, the former being the active component. In other words, the terminology “ABC” refers to a chemical designed to extinguish class A, B, and C fires. The terminology “BC” refers to a chemical designed to extinguish class B and C fires.

In some embodiments, the second component (i.e., the “B” side) includes a blend of polyols, catalysts, blowing agent, flame retardant, and surfactant. The combinations of polyols and industrial hemps are essential to creating the foam, and the industrial hemp is critical to increasing the insulating factor and the structural strength of the foam, while the other elements in the B side are used to control how the foam is sprayed and are also to make the foam flame retardant.

In some embodiments, the first blowing agent and the second blowing agent are liquid blowing agents or gas blowing agents.

In certain embodiments, the first blowing agent includes a gaseous blowing agent, such as a hydrohaloolefin, carbon dioxide, nitrogen, compressed air, a hydrocarbon, a halogenated hydrocarbon, a hydrofluorocarbon, or a combination thereof. Preferably, the gaseous first blowing agent includes 1,3,3,3-tetrafluoropropene (HFO 1234ze) in an amount of about 5% to 12% by weight.

In another embodiment, the first blowing agent is a liquid blowing agent, for example, to reduce the viscosity of the first component of the composition. The liquid blowing agent includes, but is not limited to, a hydrohaloolefin, a hydrochlorofluoroolefin; (Z)-1,1,1,4,4,4-hexafluoro-2-butene, a chloroalkene, a fluorocarbon, an alkoxyalkane, an alkyl alkanoate, a hydrocarbon, a dialkyl ether, a chlorocarbon, a chlorofluorocarbon, trichlorotrifluoroethane (CFC-113), dichlorotetrafluoroethane (CFC-114)), a hydrofluorocarbon, difluoromethane (HFC-32), pentafluoroethane (HFC-125), 1,1,2,2,-tetrafluoroethane (HFC-134), 1,1,1,2-tetrafluoroethane (HFC-134a), 1,2-difluoroethane (HFC-142), 1,1,1,3,3-pentafluoropropane (HFC-245fa)), a hydrochlorofluorocarbon (e.g., chlorodifluoromethane (HCFC-22), 1,1-dichloro-2,2,2-trifluoroethane (HCFC-123), 1-chloro-1,1-difluoroethane (HCFC-142b)), an ether (e.g., furan, dimethyl ether, diethyl ether), an ester, an aldehyde, a ketone (e.g., acetone, methyl ethyl ketone), or a combination thereof.

In some embodiments, the second blowing agent is similar to the first blowing agent.

In one embodiment, the second component further includes 0.1% to about 10% by weight surfactant, preferably 0.5% to about 5% by weight surfactant, and more preferably 1% by weight to about 3% by weight surfactant. In one embodiment, the surfactant includes a non-siloxane surfactant suitable for use in polyurethane compositions including alkoxylate, ethoxylate, poly- and monoglucoside, as well as anionic or nonionic materials. In another embodiment, the surfactant includes a siloxane surfactant. Examples of suitable siloxane surfactants are polydimethylsiloxane and polyether-polysiloxane copolymers. Siloxane surfactants provide rapid emulsification of the polyurethane reactants.

In certain embodiments, the polyol further includes a metal catalyst, which is used to accelerate the polyurethane polymerization reaction.

In some embodiments, the second component further includes less than 1% nitrogen based on the weight of the polyol.

The compositions described herein can be useful for any known polyurethane foam application.

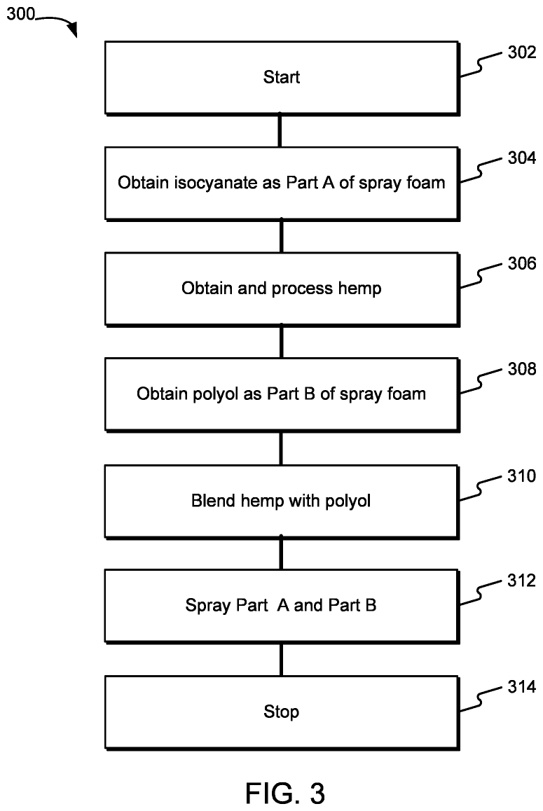

FIG. 3 depicts a flow diagram of a method 300 for preparing an industrial hemp infused PU spray foam, in accordance with embodiments of the invention. FIG. 3 will be described with continued reference to prior figures, including FIGS. 1-2. The following process is exemplary and not confined to the steps described hereafter. Moreover, alternative embodiments may include more or less steps than are shown or described herein and may include these steps in a different order than the order described in the following example embodiments.

The method 300 starts at step 302. At step 304, the method 300 includes obtaining isocyanate from the first container 102, as “Part A” of the PU spray foam (referred to as the first component). At step 306, the method 300 includes obtaining industrial hemp (e.g., industrial hemp) and processing the industrial hemp. In certain embodiments, the step 306 is performed before the step 304, or the step 304 and the step 306 are performed simultaneously.

At step 308, the method 300 includes obtaining polyol as “Part B” of the PU spray foam from the second container 104. In certain embodiments, the step 308 is performed before the step 304 and the step 306; or the step 304, the step 306, and the step 308 are performed simultaneously.

At step 310, the method 300 includes blending the processed industrial hemp with polyol (and other components) to form the “Part B” of the PU spray foam (e.g., “updated” or “improved” Part B, referred to as the second component), for example, in the second container 104.

At step 312, the method 300 includes spraying the “Part A” and “Part B” simultaneously from the spray gun 110. Specifically, once the industrial hemp is blended with polyol, the spray gun 110 is turned on. Once the spray gun 110 is turned on, the isocyanate and the blend of polyol and industrial hemp are mixed together upon exit of the spray gun 110, and a chemical reaction takes place once the chemicals (isocyanate and polyol and industrial hemp) exit the spray gun 110. Specifically, the chemicals react to create the spray foam, and the industrial hemp fibers are intertwined to create the industrial hemp infused PU spray foam.

In some embodiments, when the isocyanate and the mixture of polyol and industrial hemp are sprayed, the isocyanate chemically reacts with the mixture of polyol and industrial hemp, and that chemical reaction forms the disclosed industrial hemp infused PU spray foam on the wall 200, as described above. The disclosed industrial hemp infused PU spray foam is then dried in place on the wall 200.

The method 300 preferably ends at step 314.

In certain embodiments, the first component and the second component are prepared and packaged in separate containers (e.g., the first container 102 and the second container 104) for dispensing. To prepare the first component, the first container 102 is charged with isocyanate, optional blowing agent and/or other additives. To prepare the second component, polyol is combined with industrial hemp, metal catalyst, optional blowing agent, optional surfactant, and optional additives at room temperature. The second container 104 is charged with the polyol, industrial hemp and/or other components described above.

In some embodiments, the process/method for the preparation of the industrial hemp infused PU spray foam includes adding processed industrial hemp fiber to the polyol (“Part B”) in its original state. Thereafter, the spray gun 110 sprays Part A and Part B simultaneously. Once Part A and Part B (having industrial hemp) come in contact, the industrial hemp infused PU spray foam is formed. Preferably, as disclosed herein, the industrial hemp is mixed in the B side only before it is sprayed through the spray gun 110.

Once industrial hemp is introduced to the B side and it comes in contact with the A side upon a mixing and spraying of the A side and the B side to form the composition, it was discovered that an increase in the amount by weight of industrial hemp exhibited an increase the R-value of the resulting foam as well as exhibited an increase in the structural strength of the foam. Advantages of the disclosed invention include an increased R-value for insulation, an increase in structural strength of the foam cells and resulting increased structural integrity of structures onto which the composition is sprayed.

The term “R-Value” refers to the thermal resistance to heat flow. The insulation properties of a product are more effective when the product has a higher R-value.

In contrast to traditional spray foam, the disclosed industrial hemp infused PU spray foam insulation has a higher R value and is structurally stronger than conventional foams. The industrial hemp fibers bind to isocyanate and polyol, thereby significantly increasing the strength and the insulation value (R-value) of the disclosed hemp-infused spray foam.

For a polyurethane spray foam composition, it is preferred that the composition is stable for at least six months, and preferably for approximately 7 to 12 months or more, when stored in two component spray foam containers of “A” side component (in the first container 102) and “B” side component (in the second container 104) at room temperature (77° F.) and at pressure of 800 psi or less, typically 300 psi or less. It has been discovered that the composition disclosed in the present disclosure has the desired shelf life.

It is also preferred that the composition undergoes no more than 75% change in chemical reactivity when the composition is stored at a temperature of 120° F. for a time period of six weeks as compared to the chemical reactivity of the composition at the time of manufacture as measured under the same conditions. It has been discovered that the composition disclosed in the present disclosure has the desired chemical reactivity characteristics, as described above.

The components that are outlined in the tables that follow were used to prepare the industrial hemp infused polyurethane spray foam forming compositions.

“A”-side Component (i.e., the first component) in unit weight (e.g., grams).

| | | | | | |
|---|---|---|---|---|---|
| Isocyanate (including blowing | 453.0 | 453.0 | 453.0 | 453.0 | 453.0 |
| agent and other components) | | | | | |

“B”-side Component (i.e., the second component) in unit weight (e.g., grams).

| | | | | | |
|---|---|---|---|---|---|
| Amino polyol (including | 226.5 | 339.75 | 396.37 | 415.25 | 424.7 |
| Flame Retardant, | | | | | |
| blowing agent, and | | | | | |
| other components) | | | | | |
| Industrial Hemp | 226.50 | 113.25 | 56.63 | 37.75 | 28.3 |

In distinct containers, the mixtures of all components of the “A” and “B” sides (i.e., the first component and the second component) were prepared separately. A high-pressure spray foam applicator was used to mix an unaltered pair of component containers having respective “A” and “B” sides under typical laboratory conditions, mimicking ordinary application conditions for polyurethane spray foam applications. The “fresh sample”, or the sample at the time of manufacture, was used to test and compare the insulating and structural characteristics of the compositions disclosed herein.

In other embodiments, a low-pressure spray foam applicator can be used to mix an unaltered pair of component containers having respective “A” and “B” sides in typical application conditions.

Through embodiment disclosed herein, it is clear that in new home construction, new commercial building construction (such as for example, new warehouses), and in new industrial construction, builders and owners can find that the disclosed industrial hemp infused spray foam insulation is a very effective way to save on energy and greatly improve the comfort of the new structures as well as the structural strength and rigidity of the new structures. The spray application of the disclosed industrial hemp infused spray foam invention disclosed herein creates a continuous barrier on any surface, corner, or contour. The disclosed industrial hemp infused spray foam can be either open or closed cell, through embodiments of the different compositions disclosed herein. As can appreciated from this disclosure, embodiments of the disclosed compositions translate to many advantages over conventional spray foam insulations.

Except as may be expressly otherwise indicated, the article “a” or “an” if and as used herein is not intended to limit, and should not be construed as limiting, the description or a claim to a single element to which the article refers. Rather, the article “a” or “an” if and as used herein is intended to cover one or more such elements, unless the text expressly indicates otherwise.

This invention is susceptible to considerable variation within the spirit and scope of the appended claims.

The claimed invention is:

1. A polyurethane spray foam forming composition, the composition comprising:
a first component comprising isocyanate; and
a second component comprising a mixture of polyol and industrial hemp, wherein the first component and the second component are sprayed and mixed simultaneously to form an industrial hemp infused polyurethane spray foam.

2. The composition of claim 1, wherein the first component comprises 100%, by weight, isocyanate, and wherein the second component comprises 1%-85% by weight industrial hemp and 15%-99% by weight polyol.

3. The composition of claim 1, wherein the first component comprises 100%, by weight, isocyanate, and wherein the second component comprises 15%-75% by weight industrial hemp and 15%-75% by weight polyol.

4. The composition of claim 1, wherein the first component comprises 100%, by weight, isocyanate, and wherein the second component comprises 25%-65% by weight industrial hemp and 25%-65% by weight polyol.

5. The composition of claim 1, wherein the first component comprises 100%, by weight, isocyanate, and wherein the second component comprises 45%-55% by weight industrial emp and 45%-55% by weight polyol.

6. The composition of claim 1, wherein said composition comprises 12.5%-37.5% by weight industrial hemp, 12.5%-37.5% by weight polyol, and 50% by weight isocyanate.

7. The composition of claim 1, wherein said composition comprises 18.75%-31.25% by weight industrial hemp, 18.75%-31.25% by weight polyol, and 50% by weight isocyanate.

8. The composition of claim 1, wherein the polyol is selected from a group consisting of a polyether polyol, a polyester polyol, a polybutadiene polyol, a polycaprolactone polyol, a polycarbonate polyol, a hydroxyl-terminated polyolefin polyol, a graft polyol, a polyol derived from a natural source, and combinations thereof.

9. The composition of claim 1, wherein the isocyanate is selected from a group consisting of an aliphatic isocyanate, a cycloaliphatic isocyanate, an aromatic isocyanate, aliphatic polyisocyanate, a cycloaliphatic polyisocyanate, an aromatic polyisocyanate, and combinations thereof.

10. The composition of claim 1, wherein the first component and the second component are simultaneously mixed and sprayed in a ratio of 1:1.

11. The composition of claim 1, wherein the composition further comprises a blowing agent.

12. A polyurethane spray foam system comprising:
a first container having a first component;
a second container having a second component, wherein the first component comprises isocyanate, wherein the second component consists of a mixture of polyol and industrial hemp;
a spray gun for dispensing the first component from the first container and the second component from the second container; and
a plurality of hoses connecting the first container and the second container with the spray gun.

13. The polyurethane spray foam system of claim 12, wherein the first container comprises a first valve for dispensing the first component, and wherein the second container comprises a second valve for dispensing the second component.

14. The polyurethane spray foam system of claim 12, wherein the spray gun comprises a trigger bar switch, and wherein the spray gun dispenses the first component and the second component when the trigger bar is actuated.

15. The polyurethane spray foam system of claim 12, wherein the first component consists of 100% by weight isocyanate, wherein the second component comprises of 1%-85% by weight industrial hemp and 15%-99% by weight polyol.

16. The polyurethane spray foam system of claim 12, wherein the first component consists of 100% by weight isocyanate, wherein the second component consists of 1%-15% by weight industrial hemp and 85%-99% by weight polyol

17. The polyurethane spray foam system of claim 12, wherein the first component consists of 100% by weight isocyanate, wherein the second component consists of 15%-75% by weight industrial hemp and 25%-85% by weight polyol.

18. The polyurethane spray foam system of claim 12, wherein the first component consists of 100% by weight isocyanate, wherein the second component consists of 25%-65% by weight industrial hemp and 35%-75% by weight polyol.

19. The polyurethane spray foam system of claim 12, wherein the first component consists of 100% by weight isocyanate, wherein the second component consists of 10% by weight industrial hemp and 90% by weight polyol.

20. The polyurethane spray foam system of claim 12, wherein the first component consists of 100% by weight isocyanate, wherein the second component consists of 50% by weight industrial hemp and 50% by weight polyol.

21. The polyurethane spray foam system of claim 12, wherein the polyol is selected from a group consisting of a polyether polyol, a polyester polyol, a polybutadiene polyol, a polycaprolactone polyol, a polycarbonate polyol, a hydroxyl-terminated polyolefin polyol, a graft polyol, a polyol derived from a natural source, and combinations thereof.

22. The polyurethane spray foam system of claim 12, wherein the isocyanate is selected from a group consisting of an aliphatic isocyanate, a cycloaliphatic isocyanate, an aromatic isocyanate, aliphatic polyisocyanate, a cycloaliphatic polyisocyanate, an aromatic polyisocyanate, and combinations thereof.

23. A polyurethane spray foam composition consisting of:
0.1%-60% by weight industrial hemp;
0.1%-60% by weight polyol; and
25%-75% by weight isocyanate.

24. The polyurethane spray foam composition of claim 23, wherein said composition consists of 12.5%-37.5% by weight industrial hemp, 12.5%-37.5% by weight polyol, and 40%-60% by weight isocyanate.

25. The polyurethane spray foam composition of claim 23, wherein said composition consists of 25% by weight industrial hemp, 25% by weight polyol, and 50% by weight isocyanate.

26. A polyurethane spray foam composition consisting of:
12.5%-37.5% by weight industrial hemp;
12.5%-37.5% by weight polyol; and
50% by weight isocyanate.

27. A spray foam composition consisting of:
a first component and a second component, wherein the first component consists of 100%, by weight, isocyanate, wherein the second component consists of 1%-85% by weight industrial hemp and 15%-99% by weight polyol.

28. The spray foam composition of claim 27, wherein the first component consists of 100%, by weight, isocyanate, wherein the second component consists of 1%-15% by weight industrial hemp and 85%-99% by weight polyol.

29. The spray foam composition of claim 27, wherein the first component consists of 100%, by weight, isocyanate, wherein the second component consists of 15%-75% by weight industrial hemp and 15%-75% by weight polyol.

30. The spray foam composition of claim 27, wherein the first component of the spray foam composition consists of 100%, by weight, isocyanate, wherein the second component consists of 25%-65% by weight industrial hemp and 25%-65% by weight polyol.

31. The spray foam composition of claim 27, wherein the first component of the spray foam composition consists of 100%, by weight, isocyanate, wherein the second component consists of 50% by weight industrial hemp and 50% by weight polyol.

32. A process for preparation of a polyurethane spray foam, wherein the process comprises the steps of:
obtaining and processing industrial hemp;
obtaining isocyanate as a first component;
obtaining polyol;
mixing polyol with the processed industrial hemp to form a second component; and
spraying simultaneously the first component and the second component to obtain the polyurethane spray foam.

33. The process of claim 32, wherein the first component consists of 100% by weight isocyanate, wherein the second component consists of 1%-85% by weight industrial hemp and 15%-99% by weight polyol.

34. The process of claim 32, wherein the first component consists of 100%, by weight, isocyanate, wherein the second component consists of 1%-15% by weight industrial hemp and 85%-99% by weight polyol.

35. The process of claim 32, wherein the first component consists of 100% by weight isocyanate, wherein the second component consists of 15%-75% by weight industrial hemp and 25%-85% by weight polyol.

36. The process of claim 32, wherein the first component consists of 100% by weight isocyanate, wherein the second component consists of 25%-65% by weight industrial hemp and 35%-75% by weight polyol.

37. The process of claim 32, wherein the first component consists of 100% by weight isocyanate, wherein the second component consists of 50% by weight industrial hemp and 50% by weight polyol.

38. The process of claim 32, wherein the polyol is selected from a group consisting of a polyether polyol, a polyester polyol, a polybutadiene polyol, a polycaprolactone polyol, a polycarbonate polyol, a hydroxyl-terminated polyolefin polyol, a graft polyol, a polyol derived from a natural source, and combinations thereof.

39. The process of claim 32, wherein the isocyanate is selected from a group consisting of an aliphatic isocyanate, a cycloaliphatic isocyanate, an aromatic isocyanate, aliphatic polyisocyanate, a cycloaliphatic polyisocyanate, an aromatic polyisocyanate, and combinations thereof.
